(19) United States
(12) Patent Application Publication
(10) Pub. No.: US 2003/0148670 A1
(43) Pub. Date: Aug. 7, 2003

(54) Electrical wedge connector

(76) Inventors: Henry Maxwell, Pinehurst, NC (US); Brian W. Connor, Amherst, NH (US)

Correspondence Address: HARRINGTON & SMITH, LLP, 4 RESEARCH DRIVE, SHELTON, CT, 06484-6212, US

(21) Appl. No.: 10/068,176

(22) Filed: Feb. 6, 2002

(51) Int. Cl. H01R 4/50

(52) U.S. Cl. 439/783

(57) ABSTRACT

An electrical compression connector including a shell, a wedge and a terminal pin. The wedge is sized and shaped to be inserted into the shell to wedge conductors against opposite sides of the shell. The terminal pin includes a first section and a second section. The first section is sized and shaped to be inserted between the shell and the wedge. The second section includes a conductor receiving area which is sized and shaped to be compressed onto a conductor.

### BACKGROUND OF THE INVENTION

1. Field of the Invention

The present invention relates to electrical connectors and, more particularly, to an electrical wedge connector.

2. Brief Description of Prior Developments

Electrical wedge connectors are well known in the art. U.S. Pat. No. 3,462,543 discloses an electrical wedge connector comprising a body member, a wedge member and a connecting member which are used to connect a conductor member to another element, such as a bus bar. There is a need for a new type of connector which can connect two electrical conductors to each other, such as when the two conductors are comprised of different materials, and/or one of the conductors is much smaller than the other conductor, but which can still make use of a general electrical wedge connector design.

### SUMMARY OF THE INVENTION

In accordance with one aspect of the present invention, an electrical compression connector is provided including a shell, a wedge and a terminal pin. The wedge is sized and shaped to be inserted into the shell to wedge conductors against opposite sides of the shell. The terminal pin includes a first section and a second section. The first section is sized and shaped to be inserted between the shell and the wedge. The second section includes a conductor receiving area which is sized and shaped to be compressed onto a conductor.

In accordance with another aspect of the present invention, an electrical wedge connector is provided having a shell, a wedge adapted to be inserted into the shell, and a terminal pin. The terminal pan has a solid section and a tube section. The terminal pin having a substantially straight shape with a substantially uniform outer diameter. The solid section is sized and shaped to be inserted between the wedge and the shell. The tube section is sized and shaped to receive a conductor and be crimped onto the conductor.

In accordance with one method of the present invention, a method of connecting two conductors with an electrical wedge connector is provided comprising steps of crimping a terminal pin onto an end of a first one of the conductors, the terminal pin having a cross-sectionally solid section spaced from the conductor; inserting the solid section of the terminal pin and a second one of the conductors into a wedge connector shell; and wedging a wedge into the shell to wedge the second conductor and the solid section of the terminal pin against opposite sides of the shell.

### BRIEF DESCRIPTION OF THE DRAWINGS

The foregoing aspects and other features of the present invention are explained in the following description, taken in connection with the accompanying drawings, wherein:

FIG. 1 is an exploded perspective view of an electrical connector incorporating features of the present invention and two electrical conductors intended to be connected by the electrical connector;

FIG. 2 is a cross sectional view of one of the elements of the electrical connector shown in FIG. 1; and

FIG. 3 is a side elevational view of the element shown in FIG. 2 shown connected to one of the electrical conductors.

### DETAILED DESCRIPTION OF THE PREFERRED EMBODIMENT

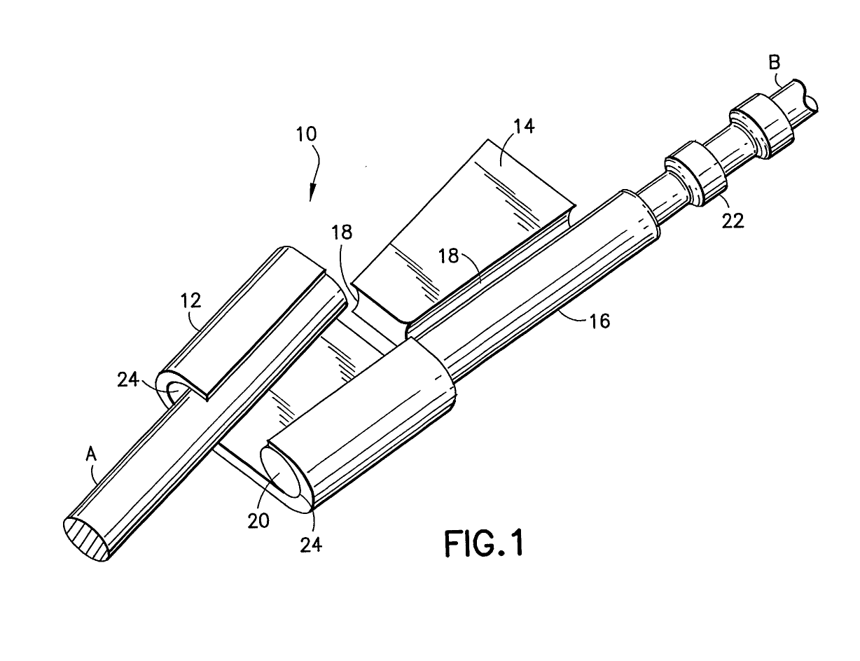

Referring to FIG. 1, there is shown an exploded perspective view of an electrical connector 10 incorporating features of the present invention and two electrical conductors A, B. Although the present invention will be described with reference to the single embodiment shown in the drawings, it should be understood that the present invention can be embodied in many alternate forms of embodiments. In addition, any suitable size, shape or type of elements or materials could be used.

The connector 10, in the embodiment shown, is an electrical wedge connector. The connector 10 generally comprises a shell 12, a wedge 14, and a terminal pin 16. The shell 12 is preferably comprised of a one-piece member made of electrically conductive material such as metal. The shell 12 has a general C shaped cross section and a general wedge shape between its front end and its rear end. Various different wedge connector shells are known in the art and can be used in practicing the present invention. Thus, in alternate embodiments, any suitable type of wedge connector shell could be used.

The wedge 14 preferably comprises a one-piece member comprised of electrically conductive material such as metal. The wedge 14 has a general wedge shape between its front end and its rear end. In the embodiment shown, the wedge 14 comprises conductor contacting grooves 18 on opposite sides of the wedge. Various different wedge connector wedges are known in the art and can be used in practicing the present invention. Thus, in alternate embodiments, any suitable type of wedge connector wedge could be used.

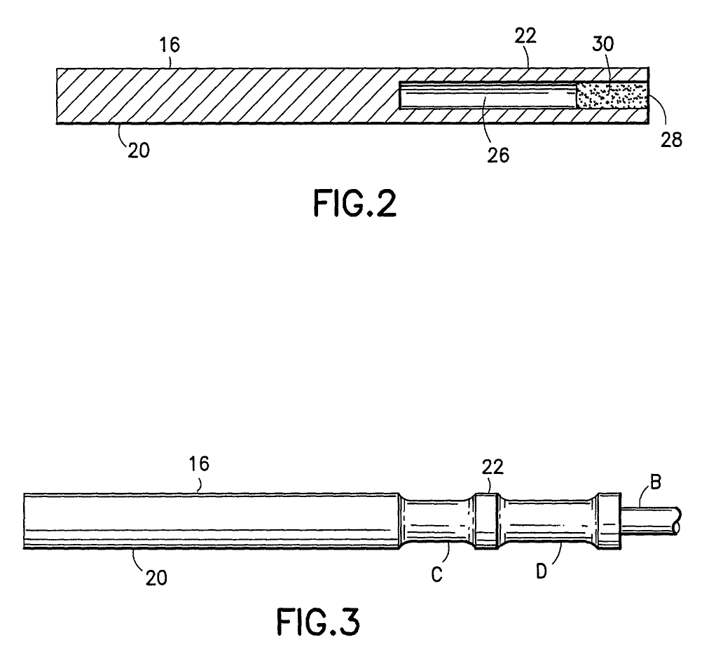

Referring also to FIG. 2, the terminal pin 16 preferably comprises a one-piece member. The one-piece member is preferably comprised of an electrically conductive material, such as metal. However, in alternate embodiments, the terminal pin 16 could be comprised of more than one member. In the embodiment shown, the terminal pin 16 has a general straight rod shape with a first section 20 and a second section 22. The terminal pin forms a uniform outer diameter along its length. However, in alternate embodiments, the terminal pin 16 could comprise any suitable type of shape and could comprise more or less than two sections.

The first section 20 has a solid cross sectional shape. However, in alternate embodiments, the first section 20 could have any suitable type of cross sectional shape. For example, the first section 20 could comprise holes therein such that the first section 20 is partially collapsible. The exterior of the first section 20, in the embodiment shown, is sized and shaped to be inserted between one of the conductor receiving grooves 24 of the shelf 12 and one of the grooves 18 of the wedge 14. Thus, when the wedge 14 is inserted into the shell 12, the wedge 14 can sandwich the conductor A and the first section 20 of the terminal pin 16 in the opposing conductor receiving areas 24 of the shell 12. In an alternate embodiment, the exterior of the first section 20 could comprise gripping barbs to assist in retaining the wedge 14 and shell 12 in fixed positions after they are assembled.

The second section 22 comprises a general tube shape. However, in alternate embodiments, the second section could comprise any suitable type of shape so long as the second section is adapted to be crimped or compressed onto the conductor B. The second section 22 comprises a coaxial interior channel 26 with an aperture 28 at an end of the terminal pin 16. The aperture 28 forms an entrance into the interior channel 26. The interior channel 26 is closed except for the entrance aperture 28. However, in an alternate embodiment, the interior channel 26 could have an open side to allow the end of the conductor B to be inserted through the open side before the terminal pin 16 is crimped onto the conductor B.

In the embodiment shown, the terminal pin 16 includes a plating 30 located on the interior side of the channel 26 proximate the entrance aperture 28. In a preferred embodiment, the plating 30 comprises tin. However, in an alternate embodiment, any suitable type of material(s) could be used for the plating 30. In another alternate embodiment, the plating 30 might not be provided.

In the embodiment shown, the conductor B is comprised of aluminum and the terminal pin 16 is comprised of copper. The tin plating 30 helps to prevent corrosion between the two members. The shell 12 and the wedge 14 are preferably comprised of copper. The conductor A is also preferably comprised of copper. However, in alternate embodiments, one or more of these components and/or the terminal pin 16 could be comprised of aluminum. The conductor B could alternatively be comprised of copper.

The aluminum conductor B has a smaller outer diameter than the outer diameter of the copper conductor A. Thus, the present invention can be used to connect a smaller aluminum conductor B with a larger copper conductor A. In alternate embodiments, the various members 12, 14, 16, A and B could be comprised of any suitable type of material s). In addition, the conductors A, B could have the same size outer diameters or any suitable type of different size outer diameters.

The interior channel 26 forms a conductor receiving area which is sized and shaped to receive an end of the conductor B therein. In an alternate embodiment, the connector 10 could comprise tubular shaped spacers (not shown) located on the end of the conductor B when the interior channel 26 is larger than the outer diameter of the conductor B. The length of the first section 22 is preferably long enough to allow one, two or three crimps of the second section 22 onto the end of the conductor B. However, in alternate embodiments, the first section 22 could comprise any suitable type of length.

Referring now also to FIG. 3, a side elevational view of the terminal pin 16 fixedly attached to the conductor B is shown. As noted above, the second section 22 comprises a general tube shape. This allows the second section 22 to be compressed or crimped onto the end of the conductor B when the conductor is located in the interior channel 26. In the embodiment shown, the terminal pin 16 has been crimped at two locations C, D. When the terminal pin 16 is crimped onto the conductor B, a fixed mechanical connection is formed as well as an electrical connection between the conductor B and the terminal pin 16. However, any suitable means could be used to fixedly electrically connect the conductor B to the terminal pin 16.

The connection of the conductor B with the terminal pin 16 could be formed before or after the terminal pin is connected with the shelf 12 and wedge 14. The wedge 14 can be inserted into the shell 12 by any suitable tool, such as a Wejtap™ tool manufactured and sold by FCI USA, Inc. The terminal pin 16 could be used to attach a tap conductor as the conductor B. The conductor B would be slid into the terminal pin and the terminal pin would be crimped onto the conductor. The terminal pin could then be assembled into the wedge connector and the Wejtap™ tool fired.

The terminal pin is preferably designed to take conductor sizes ranging from #2 to 1/0 compact and conventional AAC. However, in alternate embodiments, the terminal pin could be designed to take any suitable size of conductor. Having a terminal pin the same diameter over the entire length could reduce the chance of a burnout from an overcurrent situation; thereby preventing the connection from melting in a burnout and opening. This type of design could also decrease power losses associated with multiple joints. Ease of installation, timesaving in installing the connector, as well as cost savings in manufacturing the connector would be provided by the present invention. Crimping the conductor could be done using existing tools and dies.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical compression connector comprising:
a shell;
a wedge sized and shaped to be inserted into the shell to wedge conductors against opposite sides of the shell; and
a terminal pin comprising a first section and a second section, the first section being sized and shaped to be inserted between the shell and the wedge, and the second section comprising a conductor receiving area which is sized and shaped to be compressed onto a conductor.

2. An electrical compression connector as in claim 1 wherein the first section of the terminal pin comprises a cross-sectionally solid section.

3. An electrical compression connector as in claim 1 wherein the second section comprises a general tube shape.

4. An electrical compression connector as in claim 1 wherein the terminal pin comprises a general straight rod shape.

5. An electrical compression connector as in claim 1 wherein the terminal pin comprises a uniform outer diameter along its length.

6. An electrical compression connector as in claim 1 wherein the second section comprises a coaxial channel and at least a portion of a surface in the channel is tin plated.

7. An electrical compression connector as in claim 1 wherein the shell comprises a general cross sectional C shape.

8. An electrical compression connector as in claim 7 wherein the wedge comprises conductor receiving grooves on opposite sides of the wedge.

9. In an electrical wedge connector having a shell and a wedge adapted to be inserted into the shell, the improvement comprising:
the electrical wedge connector further comprising a terminal pin having a solid section and a tube section, the terminal pin having a substantially straight shape with a substantially uniform outer diameter, wherein the solid section is sized and shaped to be inserted between the wedge and the shell, and wherein the tube section is sized and shaped to receive a conductor and be crimped onto the conductor.

10. A method of connecting two conductors with an electrical wedge connector comprising steps of:
crimping a terminal pin onto an end of a first one of the conductors, the terminal pin having a cross-sectionally solid section spaced from the conductor;
inserting the solid section of the terminal pin and a second one of the conductors into a wedge connector shell; and
wedging a wedge into the shell to wedge the second conductor and the solid section of the terminal pin against opposite sides of the shell.

11. A method as in claim 10 wherein the step of crimping occurs before the solid section is inserted into the wedge connector shell.

12. A method as in claim 10 wherein the step of crimping occurs after the solid section is inserted into the wedge connector shell.

13. A method as in claim 10 wherein the terminal pin comprises a tube section which is crimped onto the first conductor, and wherein the tube section is spaced from the wedge connector shell when the solid section of the terminal pin is inserted into the wedge connector shell.

14. A method as in claim 10 wherein the first conductor is comprised of aluminum, the terminal pin is comprised of copper, and further comprising plating tin inside a portion of the terminal pin which is crimped onto the end of the first conductor.

15. A method as in claim 14 wherein the terminal pin comprises a tube section which the end of the first conductor is located in, and wherein an inner surface of the tube section is plated with the tin.

16. A method as in claim 10 further comprising providing the terminal pin with a general straight rod shape, a front end of the general straight rod shape comprising the cross-sectionally solid section and a rear end of the general straight rod shape comprising a coaxially aligned first conductor receiving area which is crimped onto the end of the first conductor.
